(19) United States
(12) Patent Application Publication
(10) Pub. No.: US 2005/0110181 A1
(43) Pub. Date: May 26, 2005

(54) Automotive trim component having an elastomeric skin with a foam core and method for making same

(76) Inventors: Karsten Ingwersen, Howell, MI (US); Christian Thary, West Bloomfield, MI (US); William F Klems, Troy, MI (US)

Correspondence Address: HONIGMAN MILLER SCHWARTZ AND COHN LLP, 32270 TELEGRAPH RD, SUITE 225, BINGHAM FARMS, MI, 48025-2457, US

(21) Appl. No.: 10/312,944

(22) PCT Filed: Jul. 2, 2001
(86) PCT No.: PCT/US01/21027

Related U.S. Application Data
(62) Division of application No. 60/215,425, filed on Jun. 30, 2000.

(51) Int. Cl. B29C 44/12

(52) U.S. Cl. 264/46.5

(57) ABSTRACT

A mold assembly for manufacturing a trim component of an automotive vehicle. The mold assembly comprises a first mold half having a contoured first mold surface and an outer peripheral edge and a second mold half having a contoured second mold surface and an outer peripheral edge. The mold halves pivotal about a hinge between an open position providing access to the respective mold surface and a closed position with the outer peripheral edge of the first mold half aligned with an abutting the outer peripheral edge of the second mold surface. A cutting ridge is formed around the outer peripheral edge of the first mold half for engaging a bulbous projection formed around the outer peripheral edge of the second mold halves in the closed position whereby upon the injection of a urethane material onto the mold halves, the cutting ridge abuts against the projection and perforates any oversprayed material extending outside of the mold surfaces when the mold halves are moved to the closed position.

### BACKGROUND OF THE INVENTION

1) Field of the Invention

The subject invention relates to an automotive trim component, such as a headrest, armrest or the like. Further, the subject invention also relates to a mold assembly and method for manufacturing the aforementioned automotive trim component.

2) Description of the Related Art

Automotive trim components, such as headrests and armrests, and their general method of manufacture are known in the art. For example, a conventional method for making headrests includes the following steps. Initially, a plurality of trim cover pieces are manually, either by machine or by hand, sewn together to form a trim cover envelope, also known in the art as an outer shell of the headrest. The outer shell includes sewn seams throughout. Next, the sewn outer shell is positioned into cavity of a mold assembly. Foam is then injected into the sewn outer shell while in the mold assembly to form the headrest. Such conventional methods for making headrests have a number of deficiencies. In particular, upon injecting foam into the sewn outer shell, foam may leak through the sewn seams in the headrest and result in a defective headrest. Further, automotive seating headrests with the sewn seams are prone to tearing, ripping, snagging, and opening during repeated use over the life of an automobile.

Illustrative of another example, an alternative method of making a headrest is disclosed in U.S. Pat. No. 5,116,557 wherein the outer shell or layer of the headrest is synthetically made of an elastomer within a mold tool. The mold tool includes a pair of mold halves which form a hermetic seal when closed together. The method as disclosed in the '557 patent requires that the elastomer be in a substantially liquid state during the closing of the mold halves in order to press the elastomer which may have been oversprayed onto the mold halves out from between the mold halves. This method is overly sensitive to the specific curing times of the elastomer and outside factors such as humidity, temperature and the like.

### SUMMARY OF THE INVENTION

According to one aspect of the invention, a mold assembly is provided for manufacturing a trim component of an automotive vehicle. The mold assembly comprises a first mold half having a contoured mold surface and an outer peripheral edge and a second mold half having a contoured mold surface and an outer peripheral edge. The mold halves are movable between an open position providing access to the respective mold surfaces and a closed position with the outer peripheral edge of the first mold half aligned with and abutting the outer peripheral edge of the second mold surface. A cutting ridge is formed around the outer peripheral edge of one of the mold halves for engaging the other of the mold halves in the closed position whereby upon the injection of a urethane material onto at least one of the mold halves, the cutting ridge perforates any oversprayed material extending outside of the mold surfaces when the mold halves are moved to the closed position.

According to another aspect of the invention, a method is provided for manufacturing a trim component for an automotive vehicle with a mold assembly having a first mold half having a first mold surface and a cutting ridge surrounding the first mold surface and a second mold half having a second mold surface and a projection surrounding the second mold surface, wherein the mold halves are moveable relative to each other between an open position having the cutting ridge disengaged from the projection and a closed position having the cutting ridge engage the projection. The method comprises the steps of applying an in-mold coat to each of the mold halves when the mold halves are in the open position; applying a skin coat to each in-mold coat when the mold halves are in the open position, whereby the skin coat in the first mold half bonds with the respective in-mold coat to form a first structural skin coat in the second mold half bonds with the respective in-mold coat to form a second structural skin; moving the mold halves to the closed position whereby the cutting ridge abuts the projection to cut any overspray of in-mold coat and skin coat extending outside of the first and second mold surfaces; injecting a foam into the mold halves after applying the skin coat to expand and cure between the first and second structural skins forming the trim component; moving the mold halves to the open position after forming the trim component; and removing the trim component from the mold assembly after moving the mold halves to the open position.

### BRIEF DESCRIPTION OF THE DRAWINGS

Advantages of the present invention will be readily appreciated as the same becomes understood by reference to the following detailed description when considered in connection with the accompanying wherein:

FIG. 1 is a sectional view of a mold assembly for manufacturing a trim component shown in an open position; and

FIG. 2 is a sectional view of the mold assembly shown in a closed position.

### DETAILED DESCRIPTION OF THE PREFERRED EMBODIMENT

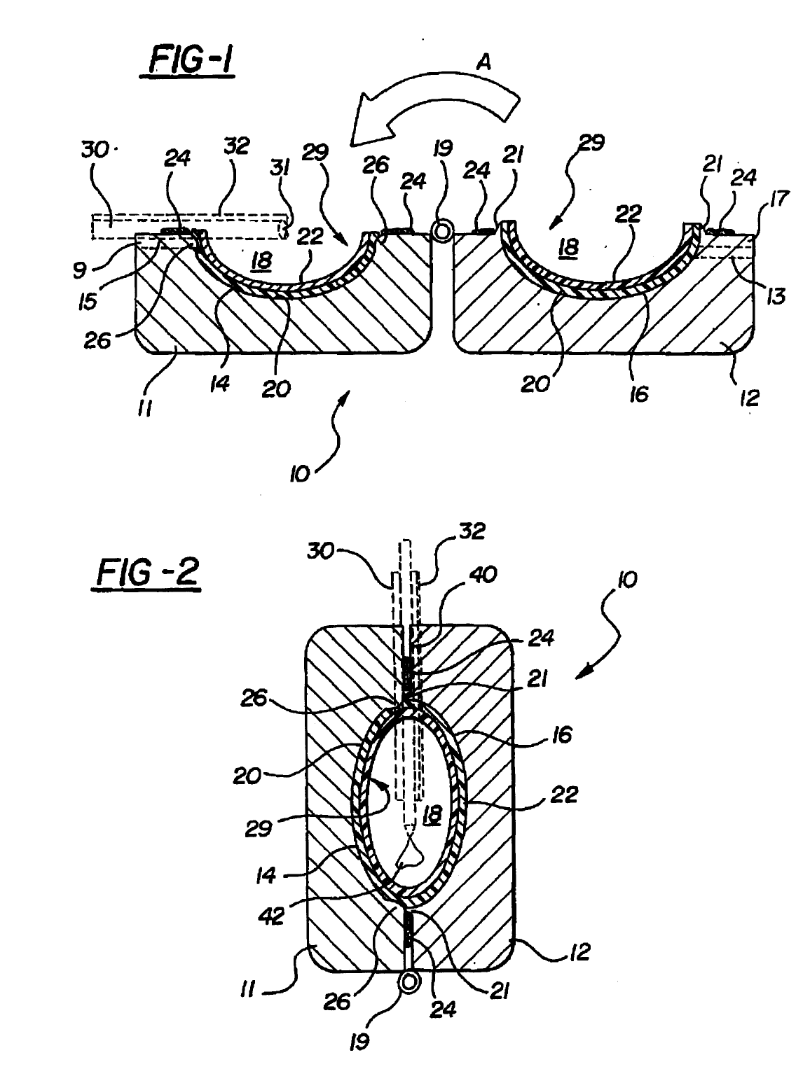

Referring to the Figures, wherein like numerals indicate like or corresponding parts throughout the several views, a mold assembly for making an automotive trim component is generally shown at 10 in FIGS. 1 and 2. For illustrative purposes only, the mold assembly 10 is depicted as a mold assembly for making a headrest. It should be appreciated that the mold assembly 10 may be configured to make any other suitable trim components, such as armrests or the like.

Referring to FIG. 1, the mold assembly 10 includes a first mold half 11 and a second mold half 12. The mold halves 11, 12 are movable relative to each other between an open position, as shown in FIG. 1, and a closed position, as shown in FIG. 2. The first and second mold halves 11, 12 include first and second contoured mold surfaces 14, 16, respectively. The mold surfaces 14, 16 are concave and complimentary to each other such that the molded surfaces 14, 16 define a substantially enclosed mold cavity 18 when the mold assembly 10 is in the closed position. The surfaces of the mold surfaces 14, 16 defining the mold cavity 18 correspond to an outer contour of the headrest (not shown in the Figures). The mold surfaces 14, 16 preferably include a textured surface that forms a final surface texture of the headrest. It should be appreciated that while the mold surfaces 14, 16 are illustrated as concave, the mold surfaces 14, 16 may be of any suitable shape so as to define a cavity commensurate with the desired shape of the headrest.

The mold halves 11, 12 further include first and second receiving recessed channels 15, 17, respectively, and a hinge 19, such as a piano-type hinge, interconnecting the mold halves 11, 12 opposite the channels 15, 17 for providing pivotal movement of the mold halves 11, 12 between the open and closed positions. The operation of these components will be described further hereinbelow. Additionally, a filler port 9, 13 is disposed within each of the first 11 and second 12 mold halves, respectively, to receive an injection funnel 40, as will be described in greater detail below.

The second mold half 12 includes a peripheral cutting ridge 21 surrounding the circumference of the opening defined by the second mold surface 16. The size of the cutting ridge 21 is exaggerated in the Figures. The cutting ridge 21 is shown as a substantially triangular barb having a sharp leading edge. Alternatively, the cutting ridge 21 may have any shape or configuration suitable for performing a cutting operation described below.

The first mold half 11 includes a projection or lip 26 extending from and surrounding the circumference of the opening defined by the first mold surface 14. The projection 26 acts as cutting board for the cutting ridge 21 as further described below. Additionally, the projection 26 provides an indentation in the completed headrest so to convey the appearance of headrest being formed of two pieces. Preferably, the first mold surface 14 is slightly deeper than the second mold surface 16 such that the projection 26 is centered on the completed headrest. In other words, the first 14 and second 16 mold surfaces are preferably designed such that when the mold halves 11, 12 are closed, the projection 26 is in the center of the headrest. The projection 26 is shown as having a bulbous semi-circular configuration. It should be appreciated that the projection 26 may have any suitable configuration depending upon the desired effect for the trim component being manufactured.

In forming the headrest, the mold assembly 10 is initially placed in the open position as shown in FIG. 1. An in-mold coat 20 is then applied to each of the mold surfaces 14, 16. It is optional that a mold-release coat is applied to each of the mold surfaces 14, 16 prior to the in-mold coating 20 to promote efficient removal of the headrest from the mold assembly 10 after the forming process is complete. The in-mold coat 20 is preferably applied in a generally uniform manner to promote consistent gloss, texture, and color of the outer contour of the seating headrest. Preferably, the in-mold coat 20 is a waterborne urethane coating, which can be applied by an air-atomized coating applicator such as a spray gun or bell applicator. Alternatively, the composition and means of applying the in-mold coat 20 may be of any suitable type. A skin coat 22 is next applied to the in-mold coat 20 in a manner similar to application of the in-mold coat 20. The composition of the skin coat 22 is preferably a two component polyurethane elastomer including a polyol component and an isocyanate component as disclosed and described in U.S. Pat. No. 5,885,662 which is incorporated herein by reference in its entirety. The in-mold coat 20 applied to each mold half 11, 12 bonds to the respective skin coat 22 to form a structural skin 29.

During the application of the in-mold coat 20 and the skin coat 22, a certain amount of overspray 24 can accumulate on the mold halves 11, 12 outside of the mold surfaces 14, 16 and outside of the cutting ridge 21 and projection 26. For illustrative purposes, the overspray 24 is exaggerated in the Figures.

A pair of elongated headrest armatures 30, which function as a support of the headrest to an automotive seat, are then inserted into the respective receiving channels 15, 17 of a designated one of the mold halves 11, 12 such that the armature 30 extend into the mold cavity 18. The headrest armatures 30 are preferably connected to a cross member 31 to form a U-shaped support. The U-shaped support may be an integral U-shaped tube having a solid or hollow construction. Alternatively, the U-shaped support may have a pair of separate armature posts 30 connected to a separate cross member by any suitable attachment means. In addition, there may be two separated armatures 30 without a cross member or even a single armature 30. Each armature 30 has at least one air channel 32 formed longitudinally therein that is in fluid communication with the mold cavity 18 for venting the mold cavity 18 as further discussed below. The air channels 32 may be notches formed in the outer surfaces of the armatures 30 or may be vent holes formed in armatures 30 that are hollow. The armatures 30 are held in place by a clamp, toggle, or the like. It should be appreciated that the armatures 30 may be placed in the designated mold half 11, 12 prior application of the mold-release coat, the in-mold coat 20 or the skin coat 22.

Once the in-mold 20 and skin coat 22 are applied and with the armatures 30 held in the respective receiving channels 15, 17, the injection funnel 40 is then inserted into the filler port 9, 13 of a designated one of mold halves 11, 12.

The mold assembly 10 is then placed in the closed position as shown in FIG. 2 by rotating the second mold half 12 about the hinge 19 (the movement of which is represented by Arrow A). As the mold assembly 10 is placed in the closed position, the armatures 30 and the funnel 40 are received in the other receiving channel 15, 17 and the other filler port 9, 13, respectively, thereby enabling complete closure of the second mold half 12 relative to the first mold half 11. It should be appreciated that the hinge 19 is optional, and that the mold assembly 10 may alternatively be placed in the closed position by moving the mold halves 11, 12 relative to each other in any suitable manner including linear movement, arcuate movement or a combination linear and arcuate movements.

As the mold halves 11, 12 are moved to the closed position, the peripheral cutting ridge 21 cuts through the overspray 24 of the coats 20, 22 on the mold halves 11, 12 and into abutment with the projection 26. The cutting ridge 21 and projection 26 extend around the entire perimeter of the mold cavity 18 such that any overspray 24 on the mold halves 11, 12 will be cut by the ridge 21. When the cutting ridge 21 abuts the projection 26, the mold assembly 10 is in the closed position.

Before the mold halves 11, 12 are moved to the closed position, the coats 20, 22 are allowed to at least partially harden to a non-liquid or gel state. The non-liquid or gel state of the coats 20, 22 promotes the cutting of the overspray 24 during the closing of the mold halves 11, 12.

Once the mold halves 11, 12 have reached, or just prior to reaching, the closed position, the mold halves 11, 12 are mechanically clamped or locked together to ensure that the mold assembly is properly placed and held in the closed position.

When in the closed position, the coats 20, 22 of the first mold half 11 bond with the coats 20, 22 of the second mold half 12 at the junction between the mold halves 11, 12. That is, the portion of the coats 20, 22 around the perimeter the first mold surface 14 bond with the portion of the coats 20, 22 around the perimeter of the second mold surface 16. The bond between the coats 20, 22 of the mold halves 11, 12 is more durable than a conventional headrest having sewn seams because the bonding of the subject invention is particularly resistant to tearing, ripping, snagging and opening during repeated use over the life of the headrest.

A cellular foam filler 42 is then injected through the funnel 40 placed in fluid communication with the mold cavity 18. Alternatively, provided that the armatures 30 are hollow, the foam filler 42 may be injected through an opening formed in either or both of the armatures 30. An advantage of injecting the foam filler 42 through the armatures 30 is that the foam filler 42 has additional time to blend into a proper mixture.

The cellular foam filler 42 expands in the mold cavity 18 and bonds with the armatures 30 and the structural skin 29, formed by the coats 20, 22, to form the headrest.

The foam filler 42 is preferably urethane and may be manufactured of a color that is complementary to the color of the structural skin 29, which provides the advantage of partially concealing any tears, cuts or breakage in the structural skin 29 that may occur during the life of the headrest.

The air channels 32 formed in the armatures 30 allow gases to escape from the cavity 18 as the foam filler 42 occupies the cavity 18. Alternatively, gases may be vented through one or more vent holes formed in the armatures 30. As a further alternative, provided that the armatures 30 utilize the U-shaped cross member 31 that is hollow, one of the armatures 30 may have inlet opening external to the cavity 18 and one or more fill holes in fluid communication with the cavity 18 for facilitating the injection of the foam filler 42. The other armature 30 may have an outer opening external to the cavity 18 and one or more vent holes in fluid communication with the cavity 18 for facilitating the venting of gases. In this embodiment, the foam filler 42 is injected into the cavity 18 trough the inlet opening via the fill holes, and gases escape the cavity 18 through outlet opening via the vent holes. It should be further appreciated that the injecting and venting may be further facilitated through apertures formed in the cross member having a hollow construction.

Preferably, the mold halves 11, 12 are manipulated 90 degrees before the injection of the foam filler 42 such that the armature 30 extends upwardly (as shown in FIG. 2). The 90 degree rotation assists in venting the mold cavity 18 during the foam injection.

The structural skin 29 is allowed to expand in the mold cavity 18 and cure and then the mold halves 11, 12 are opened to remove the completed headrest. Finally, if necessary, the subject invention may include a step of deflashing excess structural skin 29 at the bonding line created between the mold halves 11, 12.

As stated above, the completed headrest conveys the appearance of being formed of two pieces as provided by the indentation formed by the projection 26. Such a headrest may be regarded as a more aesthetically pleasing than a conventional headrest having sewn seams.

An alternative embodiment of the subject invention proceeds as follows. With the mold halves 11, 12 in the open position, the in-mold coat 20 and the skin coat 22 are applied as introduced and described above. Further, the armature 30 is inserted into the receiving channel 15 of the first mold half 11 as described above. However, prior to rotating the second mold half 12 about the hinge 19 to close upon the first mold half 11, the cellular foam filler 42 is injected over the skin coat 22 and the in-mold coat 20 in the first mold half 11. That is, the semi-rigid cellular foam filler 42 is injected into one of the mold halves in the open position. Next, the second mold half 12 is rotated about the hinge 19 to close upon the first mold half 11, and the first 11 and second 12 mold halves are locked together. In this alternative embodiment of the subject invention, all reactions described above occur simultaneously. That is, the in-mold coat 20 and the skin coat 22 bond to establish the structural skin 29 of the headrest, and simultaneously, the cellular foam filler 42 expands in the structural skin 29 to bond with the structural skin 29 thereby forming the complete headrest. In this embodiment, the cutting ridge 21 may remove excess, or overspilled, foam filler 42 as well as the oversprayed coats 24.

As appreciated, the use of the funnel 40 is eliminated from this alternative embodiment. One disadvantage to using the funnel 40 is that residue or overspill can be formed on the exterior of the headrest when the funnel 40 is removed. This alternative embodiment therefore eliminates any residue or overspill occurring in this manner.

The invention has been described in an illustrative manner, and it is to be understood that the terminology which has been used is intended to be in the nature of words of description rather than of limitation. Many modifications and variations of the present invention are possible in light of the above teachings. It is, therefore, to be understood that the invention may be practiced otherwise as specifically described.

1. A mold assembly for manufacturing a trim component of an automotive vehicle comprising:
a first mold half having a contoured mold surface and an outer peripheral edge;
a second mold half having a contoured mold surface and an outer peripheral edge;
said mold halves movable between an open position providing access to said respective mold and a closed position with said outer peripheral edge of said first mold half aligned with and abutting said outer peripheral edge of said second mold surface; and
a cutting ridge formed around said outer peripheral edge of one of said mold halves for engaging said other of said mold halves in said closed position whereby upon the injection of a urethane material onto at least one of said mold halves said cutting ridge perforates any oversprayed material extending outside of said mold surfaces when said mold halves are moved to said closed position.

2. A mold assembly as set forth in claim 1 further including a projection formed around said outer peripheral edge of said other of said mold halves opposite said cutting ridge for abutting with said cutting ridge with said mold halves in said closed position to thereby cut any oversprayed material therebetween.

3. A mold assembly as set forth in claim 2 further including a mold cavity defined between said mold surfaces of said first and second mold halves in said closed position.

4. A mold assembly as set forth in claim 3 wherein said cutting ridge includes a substantially triangular barb having a sharp leading edge extending upwardly adjacent said outer peripheral edge of said first mold half.

5. A mold assembly as set forth in claim 4 wherein said projection includes a generally bulbous semi-circular configuration extending upwardly adjacent said outer peripheral edge of said second mold half for abutting with said sharp leading edge of said cutting ridge with said mold halves in said closed position.

6. A mold assembly as set forth in claim 5 further including a hinge interconnecting said first and second mold halves for providing pivotal movement of said mold halves between said open and closed positions.

7. A method for manufacturing a trim component for an automotive vehicle with a mold assembly having a first mold half having a first mold surface and a cutting ridge surrounding the first mold surface and a second mold half having a second mold surface and a projection surrounding the second mold surface, wherein the mold halves are moveable relative to each other between an open position having the cutting ridge disengaged from the projection and a closed position having the cutting ridge engage the projection; said method comprising the steps of:
applying an in-mold coat to each of the mold halves when the mold halves are in the open position;
applying a skin coat to each in-mold coat when the mold halves are in the open position, whereby the skin coat in the first mold half bonds with the respective in-mold coat to form a first structural skin and the skin coat in the second mold half bonds with the respective in-mold coat to form a second structural skin;
moving the mold halves to the closed position whereby the cutting ridge abuts the projection to cut any overspray of in-mold coat and skin coat extending outside of the first and second mold surfaces;
injecting a foam into the mold halves after applying the skin coats to expand and cure between the first and second structural skins forming the trim component;
moving the mold halves to the open position after forming the trim component; and
removing the trim component from the mold assembly after moving the mold halves to the open position.

8. A method as set forth in claim 7 further including bonding the first structural skin to the second structural skin by allowing the skins to at least partially harden to a non-liquid state prior to moving the mold halves to the closed position and then abutting the first and second structural skin around the periphery of the first and second mold surfaces.

9. A method as set forth in claim 8 further including venting gas from a mold cavity formed between the mold halves in the closed position as the foam is injected between the first and second structural skins.

10. A method as set forth in claim 9 further including inserting at least one elongated hollow armature between the first and second mold halves in the closed position and injecting the foam into the mold cavity to cure around the armature as part of the trim component.

11. A method as set forth in claim 10 further including injecting the foam through the hollow armature into the mold cavity.

12. A method as set forth in claim 10 further including venting the gas in the mold cavity through the hollow armature during the injecting of the foam between the mold halves.

13. A method as set forth in claim 7 further including injecting the foam into at least one of the mold halves against the in-mold coat and skin coat prior to moving the mold halves to the closed position.

14. A method as set forth in claim 13 further including cutting any overspray of in-mold coat and skin coat and any excess foam outside the periphery of the first and second mold surfaces by abutting the cutting ridge against the projection with the mold halves in the closed position.

15. A method as set forth in claim 7 further including injecting the foam between the first and second structural skins after the mold halves are moved to the closed position and the structural skins are bonded around the periphery of the mold surfaces.
